(19) United States
(12) Patent Application Publication
(10) Pub. No.: US 2009/0276324 A1
(43) Pub. Date: Nov. 5, 2009

(54) System and method for previewing and purchasing digital content with a mobile digital storage and playback device

(75) Inventor: Leigh M. Rothschild, Sunny Isles Beach, FL (US)

Correspondence Address: CASELLA & HESPOS, 274 MADISON AVENUE, NEW YORK, NY, 10016, US

(73) Assignee: LMR Inventions, LLC, Bay Harbour Island, FL (US)

(21) Appl. No.: 12/151,165

(22) Filed: May 5, 2008

(51) Int. Cl. G06Q 30/00

(52) U.S. Cl. 705/26

(57) ABSTRACT

A system and method for previewing and purchasing digital content are provided. A method for previewing and rating digital content over a network includes accessing at least one preselected web site via a network connected media player assembly. Once the web site is accessed, at least one preview content is downloaded to the network connected media player assembly and the preview content is transferred to a portable media storage and playback device. The preview content is previewed and rated through the portable media storage and playback device and the rating of the preview content is then uploaded to the preselected web site via the network connected media player assembly. The preview content is purchased based on the user rating. Finally, the purchased preview content is downloaded to the portable media storage and playback device via the network connected media player assembly.

### BACKGROUND

1. Field of the Invention

The present disclosure relates generally to a system and method for allowing a user to access, preview and purchase digital content on non-Internet connected portable media storage and playback devices and on Internet connected mobile digital content and playback devices. More particularly, to a system and method for allowing a user to download content from the Internet, preview the content on a portable media storage and playback device, and indicate to a publisher of the content that the user would like to purchase the content, including audio and video data, for usage on both portable media storage and playback devices, mobile digital content devices and other devices, such as desktop or laptop computers.

2. Description of the Related Art

There are presently a variety of different technologies available to deliver digital media content, such as video, audio/video, etc. to users in a beneficial format. Numerous web sites now exist on the global computer network, e.g., the Internet, that provide entertainment and permit users to share, view, and communicate digital content, such as songs, videos, and movies. Examples of these sites include MySpace™, YouTube™, Friendster™, Facebook™, Revver™, among many others.

Even though many of these web sites (sometimes called community web sites) allow the users to list and promote their favorite digital content including music, videos and games, these web sites can only be accessed by Internet connected devices, such as a server, a desktop computer, a laptop computer or a notebook computer or an Internet-connected portable device. Other web sites, such as subscription music and content services and web sites, including Itunes™, Zune™, Rhapsody™, and Napster™, provide content for portable playback devices such as Apple's iPod™, Microsoft's Zune™ and other portable media devices. The trend in portable digital storage and playback devices (such as the iPod™ and Zune™) is to not allow the user to wirelessly connect to the Internet on the device.

Such non-Internet connected portable media storage and playback devices are thus not allowed direct access to these community web sites, subscription music and content services and other web sites on which potential portable digital content is available. Thus, a system and method is needed to allow a user of such non-Internet connected portable media storage and playback devices to download digital content from such web sites and preview the web site's audio and video digital content directly on their portable media storage and playback device. If the user is interested in purchasing the previewed digital content, a need exists for the user to use their portable media storage and playback device to indicate to the publisher of the content that the user would like to purchase the content, and to then effectuate the transfer of the content by an e-commerce transaction or otherwise. Similarly, a need exists for users of Internet connected mobile digital content devices to be able to similarly preview and purchase such content on and from their mobile digital content device. In addition, a need exists for a user to be able, if they wish, to notify a second user of the content so that the second user would also be able to view and purchase the content on the second user's portable or other storage and playback devices.

### SUMMARY OF THE INVENTION

A system and method to allow a user of non-Internet connected portable media storage devices to download digital content from such web sites and preview the web site's audio and video digital content directly on their portable media storage device are provided. If the user is interested in purchasing the previewed digital content, a user can use their portable media storage device to indicate to the publisher of the content that the user would like to purchase the content, and to then effectuate the transfer of the content by an e-commerce transaction or otherwise. Similarly, a method for users of Internet connected mobile digital content devices to similarly preview and purchase such content on and from their portable device is provided. In addition, a method is provided for a user, if they wish, to notify a second user of the content so that the second user would also be able to view and purchase the content on the second user's portable or other storage and playback devices.

A method for purchasing digital content over a network is provided, the method including accessing at least one preselected web site via a network connected media player assembly; downloading at least one preview content to the network connected media player assembly; transferring the at least one preview content to a portable media storage and playback device; previewing and rating the at least one selected preview content through the portable media storage and playback device; uploading the rating and the preview content to the preselected web site via the network connected media player assembly; purchasing the preview content; and downloading the purchased preview content to the portable media storage and playback device via the network connected media player assembly.

In one aspect, the purchasing of the preview content is based on the rating of the preview content.

A system for previewing and transferring digital content over a network includes at least one remote server adapted for hosting at least one preselected web site, the at least one preselected web site including a plurality of digital content and previews of digital content; at least one media player assembly comprising: a communication device configured for accessing the at least one preselected web site and receiving at least one preview of content; a synchronization module configured for previewing and storing at least one digital content received from at least one preselected web site located in a database and transferring the at least one digital content to a portable media storage and playback device; and the portable media storage and playback device adapted for previewing the at least one digital content while not connected to the network. Furthermore, the portable media storage and playback device is adapted for rating the at least one digital content and transferring the rating to the remote server via the at least one media player assembly, wherein the remote server is adapted to performing an e-commerce transition for the at least one digital content based on the rating.

According to another aspect of the present disclosure, a method for notifying others of digital content over a network is provided. The method includes accessing at least one preselected web site via a first network connected media player assembly by a first user; selecting a link corresponding to at least one digital content of the at least one preselected web site; inserting the selected link into an e-mail addressed to at least one second user and transmitting the e-mail to the at least one second user; determining if the at least one second user is accepting e-mails from the first user; if the at least one second user is accepting e-mails from the first user, downloading the at least one digital content via a second network connected media player assembly by accessing the selected link within the e-mail; and transferring the at least one digital content to a second portable media storage and playback device of the second user.

According to a further aspect of the present disclosure, a method for previewing and purchasing digital content over a network is provided, the method including accessing at least one preselected web site via a portable media storage and playback device; previewing at least one selected preview content through the portable media storage and playback device; uploading an identifier of the at least one selected preview content and an identifier of a user to at least one the preselected web site; purchasing the at least one selected preview content; and downloading the purchased at least one selected preview content to the portable media storage and playback device. In another aspect, the method includes uploading a rating of the at least one selected preview content and purchasing of the at least one selected preview content based on the rating.

### BRIEF DESCRIPTION OF THE DRAWINGS

The above and other aspects, features, and advantages of the disclosure will become more apparent in the light of the following detailed description when taken in conjunction with the accompanying drawings in which:

FIG. 1 is a diagram of exemplary system for previewing and transferring digital content in accordance with an embodiment of the present disclosure;

FIG. 2 is a flow chart illustrating for previewing and rating a selected digital content over a network in accordance with an embodiment of the present disclosure.

FIG. 3 is a flow chart illustrating a method for previewing and purchasing selected digital content in accordance with an embodiment of the present disclosure.

FIG. 4 is a flow chart illustrating a method of networking with at least one other second user with regard to the selected digital content in accordance with an embodiment,of the present disclosure.

### DETAILED DESCRIPTION

Preferred embodiments of the disclosure will be described hereinbelow with reference to the accompanying drawings. In the following description, well-know functions or constructions are not described in detail to avoid obscuring the disclosure.

A system and method for previewing and purchasing digital content, e.g. audio, video, etc., over a computer network, e.g., the Internet, via a portable media storage and playback device are provided. The system and method of the present disclosure enable a user to preview and/or load digital content into a portable media storage and playback device. The content could be audio and/or video content, such as video clips, movies, television shows and other audio/video programming, as well as audio only content, such as music or other types of developed or to be developed content. A user is provided with digital content by viewing or browsing a community web site or by a subscription to a pay-for-service web site. A subscription to a pay-for-service web site, such as iTunes™ or Zune™, is established through a user's computer or local server. A subscription web site, such as iTunes™, uses prior purchases, demographic and psychographic profiling to determine digital content that the user may want to view.

After previewing the digital content on the portable media storage and playback device, the user decides whether to purchase the selected or previewed digital content. If purchased, the selected digital content is transported from a remote server to a media player assembly (e.g. a desktop computer or local server) with any current or future digital storage medium including, but not limited to, removable memory cards, (compact flash, MMC, SD, Memory Stick, etc.) etc. Additionally, wireless transmission such as satellite, radio transmission of any type, or WiFi transmission can be utilized to transport the digital content from the remote server or web site to the media player assembly. Finally, a wired cable may be used to synchronize the portable media storage and playback device with the media player assembly.

In one embodiment, if the user decides to purchase the selected digital content, a mobile digital content device will transmit an identifier of the selected digital content desired for purchase as well as an identifier for the user to a remote server. This identifying information will be sent to the media web site on a remote server. The remote server's standard database software and a processing unit will process the request and perform an e-commerce transaction to allow the user to purchase the selected digital content. Once purchased, the selected digital content is transferred to the user's local computer or server, e.g., a network connected media player assembly, and stored in memory. The media player assembly may communicate to the server and network via any known communication link, for example, dial-up, hardwired, cable, DSL, satellite, cellular, PCS, wireless transmission (e.g., 802.11a/b/g, etc.), etc. Furthermore, the devices will communicate using the various known protocols such as Transmission Control Protocol/Internet Protocol (TCP/IP), File Transfer Protocol (FTP), Hypertext Transfer Protocol (HTTP), etc. During a purchasing transaction, the computing devices may employ Hypertext Transfer Protocol Secure (HTTPs), Secure Sockets Layer (SSL) Protocol, Secure Electronic Transaction (SEC) Protocol, etc. Once the digital content is on the local server, e.g., the user's computer, the digital content is then transferred to the user's mobile digital content device. In another embodiment, the remote server transmits the digital content directly to the mobile digital content device through wireless transmission.

It is to be appreciated that the identifier of the selected digital content may be a name of the content, an image of the CD or DVD cover, at least one frame of a video clip, an audio clip, etc. Furthermore, the identity of the user may be an e-mail address, a screen name, etc.

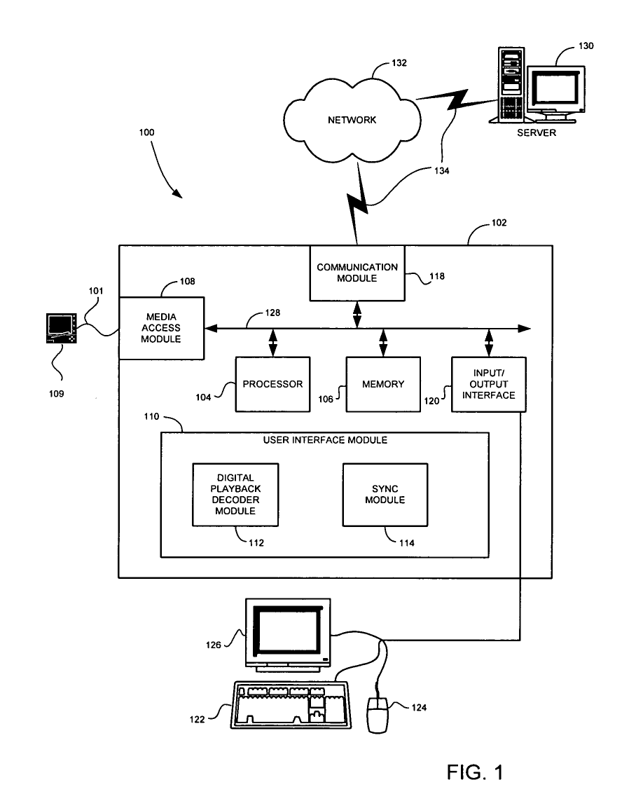

Referring to FIG. 1, system 100 for previewing and purchasing digital content is illustrated. System 100 includes media player assembly 102 for storing and delivering content to a user with computer processer 104. Media player assembly 102 will also contain digital memory storage device 106 that may be in the form of a removable hard disc or device, or may be in the form of writable memory, or may be in some other form hereto known or created in the future. Media player assembly 102 will also include mobile access module 108 for transferring digital content from media player assembly 102 to portable media storage and playback device 109. In one embodiment of the disclosure, mobile access module 108 is a USB port that will transfer data via a wired cable 101, wired cable 101 is able to transfer audio and video digital content obtained from remote server 130 and media player assembly 102 to portable media storage and playback device 109. In another embodiment, the media access device is an infrared port for transferring data via line-of-sight optical communication. In further embodiment, mobile access module 108 is a memory card reader/writer, the memory card reader/writer will read various removable memory, including but not limited to, CompactFlash, SD (Secure Digital) memory, MultiMediaCard (MMC), Memory Stick, SmartMedia and other memory currently existing or created in the future. The media card reader/writer will write data, e.g., preview content, to a media storage device such as a memory card which can then be disposed in the digital storage and playback device 109.

Media player assembly 102 contains computer instructional code that is operated by computer processer 104. The code functions to create user interface module (UIM) 110 for navigating or playing back the digital content received from various web sites such as community web sites or subscription web sites. User interface module (UIM) 110 also incorporates a digital playback decoder module 112. Digital playback decoder module 112 is standard in the art and will playback any type of digital content currently existing, but not limited to, DVR.MS files, AVI files, Mpeg (1,2,3,4,5, etc.) files, TiVo MPEG files, Divx files, Replay files, VOB, IFO files, ACC (audio) files, MP3 (audio) files, wmv (audio) files, MPEG (audio) files and any other files existing or to be created in the future. Digital playback decoder module 112 allows the user to store digital content and to selectively control the digital content. The user may control the digital content by arranging the audio digital content in several different ways, such as by artist, album, playlist, etc. The video digital content is arranged in a similar manner. Digital playback decoder module 112 control units will have different functionality and this variance in functionality is not critical to the overall disclosure. Note that digital playback decoder module 112 is not crucial to the present disclosure. Software packages are available that perform the same functionality.

User interface module (UIM) 110 also includes synchronization (SYNC) module 114 that will allow a user to synchronize digital content to and from a designated portable media storage and playback device 109. Synchronization (SYNC) module 114 is configured to read content in the form of either local content stored in memory 106 or stored on external media disposed in the media reader. Synchronization (SYNC) module 114 is configured to maintain a database of all the media web sites that the user is participating in. In one embodiment, synchronization (SYNC) module 114 will access the web sites listed and determine if new content is available. If new content is available, synchronization (SYNC) module 114 will automatically send (i.e., synch) the new content to be previewed to portable media storage and playback device 109.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by a machine, e.g., media player assembly 102, comprising any suitable architecture such as a personal computer, a workstation or server. Preferably, media player assembly 102 is implemented on a computer platform having hardware such as one or more central processing units (CPU), a random access memory (RAM), a read only memory (ROM) and input/output (I/O) interface(s) 120 such as a keyboard 122, cursor control device 124 (e.g., a mouse or joystick) and display device 126, e.g., a monitor. A system bus 128 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform of the machine by various interfaces and bus structures, such a parallel port, serial port or universal serial bus (USB). One such peripheral device may include a communication module 118, e.g., a modem, satellite relay, wireless connection, etc., for enabling communications from media player assembly 102 to various servers. Other peripheral devices may include additional storage devices, a printer and a scanner.

It is to be appreciated that although media player assembly 102 is shown as a local server, e.g. a desktop computer, media player assembly 102 may include but is not limited to a laptop computer, notebook computer, personal digital assistant (PDA), game console system, cellular or other mobile phone terminal, portable or handheld gaming system, a TV set top box, a high definition receiver, or a media player, e.g., a CD player, a DVD player, or an MP3 player. In these embodiments, the media player assembly 102 may include one or more user input devices, such as a mouse, keyboard, a touchpad, a touchscreen or a microphone (e.g., where a processor of the media player assembly executes voice recognition software and is capable of responding to voice instructions), one or more video display devices, such as a monitor, a plasma or liquid crystal display, or a television and/or one or more standalone or embedded audio output devices, such as speakers.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

Media player assembly 102 may operate in a networked environment using logical connections to one or more remote computers, e.g., server 130. Remote computer may be a personal computer, a server, a router, a network PC, a peer device or other common network node, and typically includes many or all of the elements described above relative to the machine. It is to be appreciated that network 132 may be a local area network (LAN), wide area network (WAN), the Internet or any known network that couples a plurality of computers to enable various modes of via network messages. Media player assembly 102 may communicate to server 130 and network 132 via any known communication link 134, for example, dial-up, hardwired, cable, DSL, satellite, cellular, PCS, wireless transmission (e.g., 802.11a/b/g, etc.), etc. Furthermore, the devices will communicate using the various known protocols such as Transmission Control Protocol/Internet Protocol (TCP/IP), File Transfer Protocol (FTP), Hypertext Transfer Protocol (HTTP), etc. During a purchasing transaction, the computing devices may employ Hypertext Transfer Protocol Secure (HTTPs), Secure Sockets Layer (SSL) Protocol, Secure Electronic Transaction (SEC) Protocol, etc.

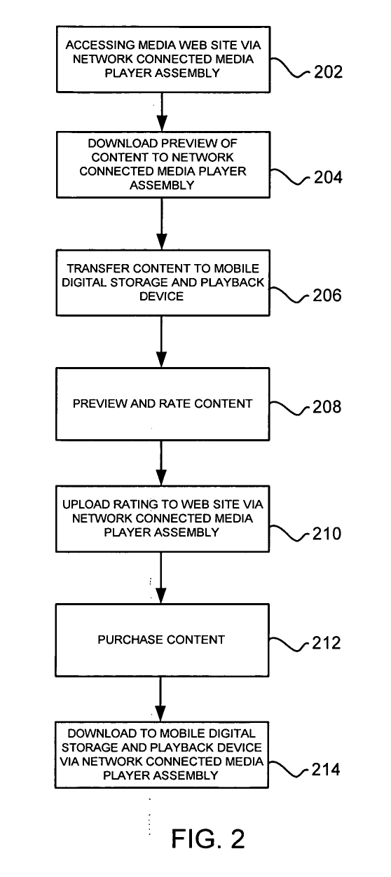

With reference to FIGS. 1 and 2, a method and a system of the present disclosure will now be described, where FIG. 2 is a flow chart illustrating a method for previewing and rating digital content over a network.

Initially, in step 202, content is accessed on a preselected web site through network 130 connected media player assembly 102. The at least one preview content is downloaded to the media player assembly 102 in step 204. The preview content may include a name, an image, and/or at least one frame of an audio or video clip. The user may be provided preview content specifically directed toward the user's interests. For example, remote server 130 includes a database that compiles data on all the preselected web sites. Remote server's 130 database provides a preselected plurality of preview content, either through subscription to a subscription web site or by the use of real simple syndication (RSS) feed. In addition, the database may include determining a user's interest in specific preview content based on demographic and/or psychographic profiling. For example, many profiles exist of digital media titles such as movies or recording artists, and these profiles contain lists corresponding to or related to the selected movies, television media and recording artists. The profiles, either through the remote server data base or through possessor and memory of the media player assembly, will generate digital content from the same genre of movies and/or television shows or audio from the same artist or similar audio choices from different artists.

In another exemplary embodiment, the preselected web sites include, but are not limited to, subscription web sites and community web sites.

In an embodiment of disclosure, the preview content is downloaded and uploaded via synchronization module 114 configured for synchronizing media player assembly 102 with portable media storage device 109. Media player assembly 102 includes media access module 108 which is configured to include a USB port, infrared port, memory slot, etc, for transferring the preview content between media player assembly 102 (local server) and portable media storage and playback device 109. In one exemplary embodiment, a USB port couples media player assembly 102 (local server) and portable media storage device 109 using wired cable 101.

In step 206, the at least one preview content is transferred to portable media storage and playback device 109. Portable media storage device 109 includes any non-Internet connected portable media storage and playback device 109 such as an iPod™ or Zune™. Once the preview content is transferred to portable media storage device 109, in step 208, the user previews the content and rates the content. The rating system may be any rating system now available including a star rating (e.g., a user selects a number of stars out of a predetermined number of stars), a number rating (e.g., a user selects a number out of a predetermined range for example on a scale of 1 to 10), etc, or any other rating system that exists now or is developed in the future. In step 210, the user uploads the previewed content (or an identifier of the preview content) along with the rating associated with content determined by the user. In the present embodiment, upon transfer from the media player assembly 102, the remote server 130 analyzes the rating given to the digital content by the user. If the user has given the digital content the highest rating possible, or a rating over a predetermined threshold previously set by the user, the remote server 130 analyzes this rating to indicate a desired purchase of the previewed digital content. The previewed and rated preview content is purchased at step 212. Using e-commerce information stored in a database at remote server 130, remote server 130 will complete an e-commerce transaction for the user.

The digital content for each media web site resides in a remote database on server 130. If the user decides to purchase the selected digital content, he or she can then use the keyboard, the mouse or voice recognition software of the local server to initialize the purchase transaction(s). Using e-commerce information (payment information and user identification information) stored in a data base at remote server 130, remote server 130 will complete the e-commerce transaction for the user. Upon completion of the purchase transaction, remote server 130 will download the digital content to media player assembly's 102 communications module 118 using the various known protocols. In step 214, network connected media player assembly 102 through media access module 108 downloads the purchased content via a wired cable 101, or any other means now known or developed in the future for transferring information between devices, to the user's portable media storage and playback device 109.

In another embodiment, the selected digital content may contain an identification code. In one embodiment, the identifier is a title of the digital content. In other embodiments, the identifier may be the image of a CD, or DVD cover in the case of a music or video, a frame of the video clip or a frame of a media clip, etc. The digital content identification code may be the title or image of a television show that the user can download. In one embodiment, the identification code may be a visual code that can be seen by the user in video content, or an audio code that is part of the audio content or both. The user will be able to access the digital content identification code and a user identifier and transmit the digital content identification, code and the user identifier to remote server 130 via media player assembly 102 (local server). It is to be appreciated that the user identifier can be the same for all web sites, e.g. a common e-mail address, or may be different for each web site, e.g. a screen login name. The transmission of the digital content identification code and user identifier may be accomplished using the various known protocols as stated above. The digital content identification code may be transmitted through an Internet device, such as a local server. Once the digital content identification code is transmitted to remote server 130, remote server 130 will use standard database processing power, to verify the digital content identification code and user identifier and complete an e-commerce transaction for the user.

In a further embodiment, the digital content identification code may be generated by the media web site for each individual user so that the code can identify the content and the user in a single code.

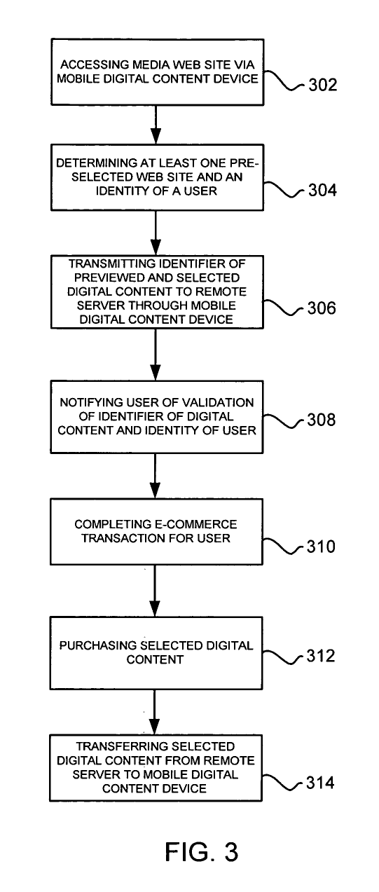

Referring to FIG. 3, in steps 302-312, the digital content is accessed through a mobile digital content device, at least one preselected web site is accessed with a user identifier, which is entered through the mobile digital content device. The user identifier is configured within a processor located within the mobile digital content device. The mobile digital content device includes a communication module, e.g., a modem, satellite relay, wireless connection, etc., for enabling a wireless transfer of the user identity from the mobile digital content device to the remote server. First, at step 302, the preselected web site is accessed by the mobile digital content device. Once the preselected web site is accessed by the user having a user identity (step 304), the user previews and selects digital content.

According to an embodiment of the disclosure, the digital content may include its own identifier. In one embodiment, the identifiable digital content is a title of the digital content. In other embodiments, the identifiable digital content may be the image of a CD, or DVD cover in the case of a music or video, a frame of the video clip, etc. Also, the identifiable digital content may be the title or image of a television show that the user can download. At step 306, the user transmits the identifier of the previewed and selected identifiable digital content along with the user identification to remote server 130 through the mobile digital content device.

In step 308, remote server will notify the user of verification or validation of the identifiable digital content and of the user identifier. Once the validity of the digital content and user are verified, the remote server completes the e-commerce transaction (step 310) for the user through the user's mobile digital content device and the selected digital content is purchased (step 312). Upon completion of the purchase transaction, the transfer of the digital content from the remote server to the mobile digital content device is made. Digital storage and playback device 109 may communicate to the server 130 and network 132 via any known communication link 134, for example, dial-up, hardwired, cable, DSL, satellite, cellular, PCS, wireless transmission (e.g., 802.11a/b/g, etc.), etc.

In another embodiment, on a subscription web site, the content provider or originator, such as iTunes™ or Zune™, may provide subscription service to a user when the user accesses the web site using his or her mobile digital content device 109, e.g., via a web-enabled media player, mobile phone, etc. In the case of a user identifier embedded in a mobile digital content device, the web site will have the information needed to create a subscription account for the user upon the user accessing the web site. The user may have to enter additional information into his or her wireless Internet access device such as payment information. In a particular embodiment, the content provider or originator, allowing subscription service, could be part of an e-commerce transaction to purchase a wireless Internet mobile access subscription. For example, should a subscriber decide to purchase a wireless Internet mobile access subscription service to a preselected web site, the user would be able to download digital content that they had not considered previously, but maybe they heard or observed and decided immediately that they wanted to purchase the digital content. Beneficially, this could cause a dramatic increase in the subscription service for such web sites. For instance, if a user has their subscription service available to them on their mobile digital content device, they can make a purchase at any time and at any place without have to wait to come home and transfer the digital content into their local server, make the purchase and transfer the content back to the mobile Internet access device. In this embodiment, the user is able to do all the above tasks at any place having a wireless connection, e.g., commuting, in airports, waiting for meetings, etc. Once the user has the digital content on the mobile Internet access device, the user can transfer the digital content to a media player assembly, e.g., a local computer, by synching the mobile device via hardwire to the media player assembly, e-mailing the digital content, transferring the digital content via a wireless network (e.g., WiFi network), etc.

In another embodiment, the software for the subscription service can be installed on the mobile digital content device when the subscription service is initiated. The playlists, and all other media functions associated with the subscription software would be readily available on a user's mobile digital content device.

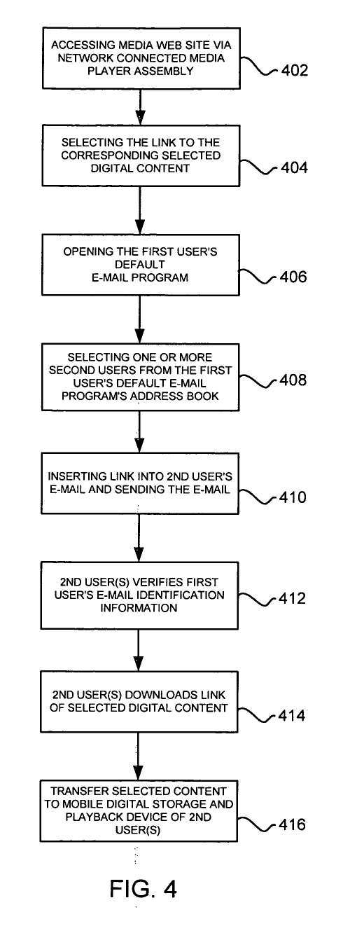

In another embodiment, the user may wish to notify another user of the digital content that they are interested in listening to or viewing. Referring to FIG. 4, the user will direct the media player assembly 102, e.g., local processor, to a web site for example a community web site (step 402), and the processor reads the identifier of a digital content, e.g. the title of the content and the URL address of the preselected web site(s) that the user wishes to interact with. The user would then indicate the link to the selected digital content via right clicking on the link, using the user's keyboard, or using voice recognition software to indicate the content (step 404). In step 406, the processor would open the user's default e-mail program, e.g. Microsoft Outlook®, Microsoft Express®, AOL®, etc. and would read a list of other users selected from the default e-mail program's address book. The user would then select the one or more second users from his or her address book (step 408). In step 410, the user would be presented with an e-mail formatted with a hyperlink to the selected digital content contained now in the e-mail and any visualization of the selected digital content that was contained in the web site. The e-mail also includes the user's (sender's) identification information and, optionally, a preselected message to one or more second users. The preselected message could be an indication of the nature of the e-mail such as “here is content for your iPod.®” Using standard e-mail protocols, the user mails the e-mail(s).

When the e-mail is received by the intended recipient(s), the one or more second users' local processor (e.g., media player assembly 102) would ascertain if the user has been approved by the one or more second users. A local database will be resident on the second user's local computer. The second user's local computer will use local processing power, along with computer algorithms, to compare the sender's identity contained in the e-mail to the database on the local computer (step 412). If the senders' e-mail is approved by the second user(s)' local computer(s), then the local computer(s) will use the hyperlink contained in the e-mail to download from a remote server the digital content whose link is contained the e-mail.

The download of the digital content will occur from the remote server 130 to transfer to the second user's local data base (step 414) using communications module 118. The second user(s) can then transfer the digital content that has been transferred to their local data base to the second user(s) mobile digital content device for the second user(s) to listen to or view (step 416).

In a further embodiment, the verifying of the e-mail, downloading the digital content by accessing the selected link and transferring the digital content to the second user's portable device will occur automatically, without the second user's intervention. In this manner, digital content received from pre-approved other users will automatically be transferred to the second users portable media storage and playback device for preview and purchased. Upon synchronizing the second user's portable media storage and playback device, the second user will be presented preview content upon powering up their device. The second user then may rate and/or purchase the content as described above.

While this disclosure has been shown and described with reference to certain preferred embodiments thereof, it will be understood by those skilled in the art that various changes in form and detail may be made therein without departing from the spirit and scope of disclosure of the appended claims.

What is claimed is:

1. A method for purchasing digital content over a network, the method comprising:
accessing at least one preselected web site via a network connected media player assembly;
downloading at least one preview content to the network connected media player assembly;
transferring the at least one preview content to a portable media storage and playback device;
previewing and rating the at least one selected preview content through the portable media storage and playback device;
uploading the rating and the preview content to the preselected web site via the network connected media player assembly;
purchasing the preview content; and
downloading the purchased preview content to the portable media storage and playback device via the network connected media player assembly.

2. The method as in claim 1, further comprising purchasing the at least one selected digital content from the preselected web site located on a remote server.

3. The method as in claim 2, wherein purchasing further comprises an e-commerce transaction via the network connected media player assembly and the remote server.

4. The method as in claim 1, wherein the purchasing of the preview content is based on the rating of the preview content.

5. The method as in claim 2, wherein the remote server further comprises a database wherein a user is provided a preselected plurality of preview content through a subscription to at least one syndication web site or by use of a really simple syndication (RSS) feed to at least one preselected web site.

6. The method as in claim 5, wherein the database includes determining a user's interest in specific preview content based on demographic or psychographic profiling of the user.

7. The method as in claim 1, wherein the uploading the preview content further comprises uploading at least one identifier of the at least one preview content.

8. The method as in claim 7, wherein the at least one identifier of the at least one preview content is a name, an image, or at least one frame of an audio or a video clip.

9. The method as in claim 7, wherein the at least one identifier of the at least one preview content includes an identity of the user.

10. The method as in claim 1, further comprising storing the purchased preview content to the network connected media player assembly for playback on the network connected media player assembly.

11. A system for previewing and transferring digital content over a network, the system comprising:
at least one remote server adapted for hosting at least one preselected web site, the at least one preselected web site including a plurality of digital content and previews of digital content;
at least one media player assembly comprising:
a communication device configured for accessing the at least one preselected web site and receiving at least one preview of content;
a synchronization module configured for previewing and storing at least one digital content received from at least one preselected web site located in a database and transferring the at least one digital content to a portable media storage and playback device; and
the portable media storage and playback device adapted for previewing the at least one digital content while not connected to the network.

12. The system as in claim 11, wherein the portable media storage and playback device is adapted for rating the at least one digital content and transferring the rating to the remote server via the at least one media player assembly.

13. The system as in claim 12, wherein the remote server is adapted to performing an e-commerce transition for the at least one digital content based on the rating.

14. The system as in claim 13, wherein upon purchase of the at least one digital content, the remote server is adapted to download the at least one digital content to the at least one media player assembly.

15. The system as in claim 14, wherein the at least one media player assembly is further adapted for storing the purchased at least one digital content in a memory of the at least one media player assembly for playback.

16. The system as in claim 14, wherein the at least one media player assembly is further adapted for transferring the purchased at least one digital content to the portable media storage and playback device.

17. The system as in claim 13, wherein the remote server further comprises a database wherein a user is provided a preselected plurality of preview content through a subscription to at least one syndication web site or by use of a really simple syndication (RSS) feed to at least one preselected web site.

18. The system as in claim 17, wherein the database includes determining a user's interest in specific preview content based on demographic or psychographic profiling of the user.

19. The system as in claim 11, wherein the at least one media player assembly is adapted for uploading at least one identifier of the at least one preview content and an identity of the user.

20. A method for notifying others of digital content over a network, the method comprising:
accessing at least one preselected web site via a first network connected media player assembly by a first user;
selecting a link corresponding to at least one digital content of the at least one preselected web site;
inserting the selected link into an e-mail addressed to at least one second user and transmitting the e-mail to the at least one second user;
determining if the at least one second user is accepting e-mails from the first user;
if the at least one second user is accepting e-mails from the first user, downloading the at least one digital content via a second network connected media player assembly by accessing the selected link within the e-mail; and
transferring the at least one digital content to a second portable media storage and playback device of the second user.

21. The method as in claim 20, further comprising:
previewing and rating the at least one digital content through the second portable media storage and playback device;
uploading the rating to the preselected web site via the second network connected media player assembly;
purchasing the at least one digital content; and
downloading the purchased at least one digital content to the second portable media storage and playback device via the second network connected media player assembly.

22. The method as in claim 20, wherein the e-mail includes a visualization of the at least one digital content.

23. The method as in claim 20, wherein the e-mail includes a preselected message indicating digital content contained therein.

24. The method as in claim 20, wherein the e-mail includes identification information of the first user.

25. The method as in claim 21, further comprising storing the purchased at least one digital content to the second network connected media player assembly for playback on the second network connected media player assembly.

26. A method for previewing and purchasing digital content over a network, the method comprising:
accessing at least one preselected web site via a portable media storage and playback device;
previewing at least one selected preview content through the portable media storage and playback device;
uploading an identifier of the at least one selected preview content and an identifier of a user to at least one the preselected web site;
purchasing the at least one selected preview content; and
downloading the purchased at least one selected preview content to the portable media storage and playback device.

27. The method as in claim 26, further comprising uploading a rating of the at least one selected preview content and purchasing of the at least one selected preview content based on the rating.

28. The method as in claim 26, further comprising purchasing the at least one selected digital content from the preselected web site located on a remote server.

29. The method as in claim 28, wherein the remote server further comprises a database wherein a user is provided a preselected plurality of preview content through a subscription to at least one syndication web site or by use of a really simple syndication (RSS) feed to at least one preselected web site.

30. The method as in claim 29, wherein the database includes determining a user's interest in specific preview content based on demographic or psychographic profiling of the user.

31. The method as in claim 26, wherein the at least one identifier of the at least one preview content is a name, an image, or at least one frame of an audio or a video clip.

32. The method as in claim 26, further comprising transferring the purchased at least one selected preview content to at least one media player assembly for playback on the at least one media player assembly.
